(19) United States
(12) Patent Application Publication
(10) Pub. No.: US 2023/0219731 A1
(43) Pub. Date: Jul. 13, 2023

(54) RECYCLABLE COMPOSITE ZIPPER BAG AND METHOD FOR PRODUCING THE SAME

(71) Applicant: SHUMMI ENTERPRISE CO., LTD., Taipei City (TW)

(72) Inventor: CHIA LIN LEE, Taipei City (TW)

(21) Appl. No.: 17/689,187

(22) Filed: Mar. 8, 2022

(30) Foreign Application Priority Data
Jan. 10, 2022 (TW) 111101020

(51) Int. Cl. B65D 65/38; B65D 33/25

(52) U.S. Cl. CPC B65D 65/38; B65D 33/25; B65D 2565/385

(57) ABSTRACT

A recyclable composite zipper bag and a method for producing the same are provided. At least two side edges of two composite films are bonded by heat seal to form the bag body of the recyclable composite zipper bag. Each composite film includes an outer layer and an inner layer. The outer layer is a BOPE film and the inner layer is a PCR PE film. The outer layer and the inner layer are combined with each other. The composite film made of BOPE and PCR PE can increase impact and puncture resistance of the recyclable composite zipper bag and favor to recycle and reuse. In the method for producing a recyclable composite zipper bag, the composite films are bonded by heat seal at a temperature of 120-130° C. in order to effectively avoid wrinkling, thereby improving the yield of products.

This application claims priority of Application No. 111101020 filed in Taiwan on 10 Jan. 2022 under 35 U.S.C. § 119; the entire contents of all of which are hereby incorporated by reference.

### BACKGROUND OF THE INVENTION

### Field of the Invention

The present invention relates to a field for packaging bags, particularly to a recyclable composite zipper bag and a method for producing the same.

### Description of the Related Art

At present, the packaging bags in the market are often made of polyethylene (PE) film with good ductility. However, because the polyethylene film is not stress-resistant, its puncture resistance is poor. For example, a zipper bag made of traditional polyethylene material is used for packaging dental floss pick. The zipper bag is easily pierced by the sharp parts of the dental floss pick and thus broken. In order to increase the puncture resistance, composite zipper bags are usually made of films of different materials. For example, polyethylene terephthalate (PET) and polyethylene are used. Because the composite zipper bags are made of different materials, it is not easy to separate them and therefore rendering the composite zipper bags not recyclable.

In order to promote the development of environmental protection, some composite zipper bags are made of post-consumer recycled polyethylene (PCR PE). The sources of PCR PE are more complex, and the physical properties of PCR PE are more unstable than those of ordinary polyethylene. Therefore, the current composite zipper bags are not made of PCR PE and other materials. Besides, PCR PE includes various polyethylene materials with different properties such as hardness, densities, and heat-resistant temperatures. As a result, the edges of the bag body of the composite zipper bag made of PCR PE and other materials are prone to wrinkle during a heat sealing process, thereby affecting printing registers or causing inconsistent specifications to reduce the yield of products.

To overcome the abovementioned problems, a recyclable composite zipper bag with puncture resistance, easy recycling and improved yield of products and a method for producing the same are provided.

### SUMMARY OF THE INVENTION

The primary objective of the present invention is to provide a recyclable composite zipper bag and a method for producing the same, wherein the bag body of the recyclable composite zipper bag is produced using a biaxially oriented polyethylene (BOPE) film and a post-consumer recycled polyethylene (PCR PE) film. The bag body can increase impact resistance and puncture resistance and achieve the purpose of recycling and reusing.

Another objective of the present invention is to provide a recyclable composite zipper bag and a method for producing the same, which bonds films by heat seal at a temperature of 120-130° C. in order to effectively avoid wrinkling, thereby improving the yield of products.

In order to achieve the foregoing objectives, the present invention provides a recyclable composite zipper bag, which includes a bag body and a zipper portion formed at the top of the bag body. At least two side edges of two composite films are bonded by heat seal to form the bag body. Each composite film includes an outer layer and an inner layer. The outer layer is a biaxially oriented polyethylene (BOPE) film. The inner layer is a post-consumer recycled polyethylene (PCR PE) film. The outer layer and the inner layer are combined with each other. The inner layers of the two composite films are opposite to each other.

The present invention also provides a method for producing a recyclable composite zipper bag, which includes:
Step 1) providing two composite films, wherein each of the two composite films includes:
   an outer layer being a biaxially oriented polyethylene (BOPE) film; and
   an inner layer being a post-consumer recycled polyethylene (PCR PE) film, wherein the outer layer and the inner layer are combined with each other;
Step 2) pressing the two composite films to form a bag body;
Step 3) installing a zipper portion at a top of the bag body; and
Step 4) bonding at least two side edges of the bag body by heat seal at a temperature of 120-130° C.

According to an embodiment of the present invention, Step 1) includes: printing the inner side of the outer layer and gluing or heating the printed outer layer and the inner layer to combine the printed outer layer with the inner layer.

According to an embodiment of the present invention, the post-consumer recycled polyethylene film comprises at least one of high density polyethylene (HDPE), medium density polyethylene (MDPE), low density polyethylene (LDPE), ultra-low density polyethylene (ULDPE), and linear low density polyethylene (LLDPE).

According to an embodiment of the present invention, the weight ratio of the outer layer to the inner layer of the composite film is 3/7-2/3.

According to an embodiment of the present invention, the inner layer has a thickness of 20-100 μm and the outer layer has a thickness of 15-70 μm.

Compared with the conventional technology, the present invention has the following advantages:
(1) The recyclable composite zipper bag of the present invention includes a biaxially oriented polyethylene (BOPE) film that can increase the impact and puncture resistance of polyethylene packaged products.
(2) The present invention uses a composite film that includes a biaxially oriented polyethylene (BOPE) film and a post-consumer recycled polyethylene (PCR PE) film. Because BOPE and PCR PE both belong to polyethylene, they can be directly recycled and reused. PCR PE is a recycled material that can achieve the ideal goal of plastic reduction and sustainable development.
(3) The present invention provides a method for producing a recyclable composite zipper bag, wherein the method has a simple production process. The process is designed to have a temperature range higher than the bonding temperature of ordinary polyethylene to avoid wrinkling, thereby producing a zipper bag that combines the BOPE film with the PCR PE film.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a recyclable composite zipper bag according to an embodiment of the present invention;

FIG. 2 is a cross-sectional view of a bag body according to an embodiment of the present invention; and

FIG. 3 is a flowchart of a method for producing a recyclable composite zipper bag according to an embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

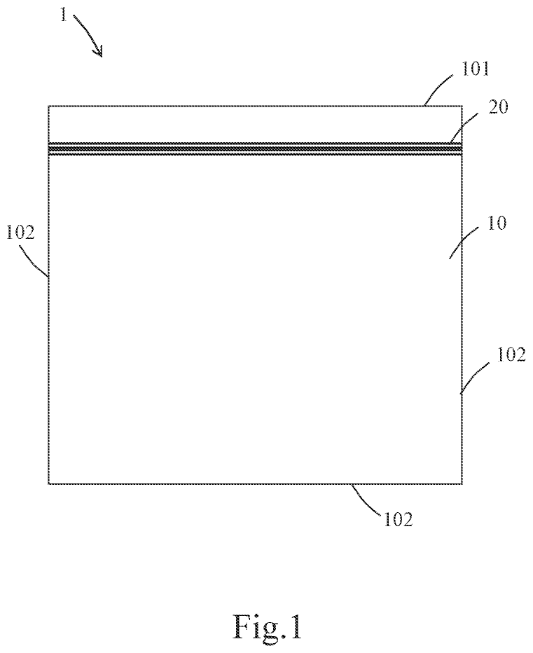

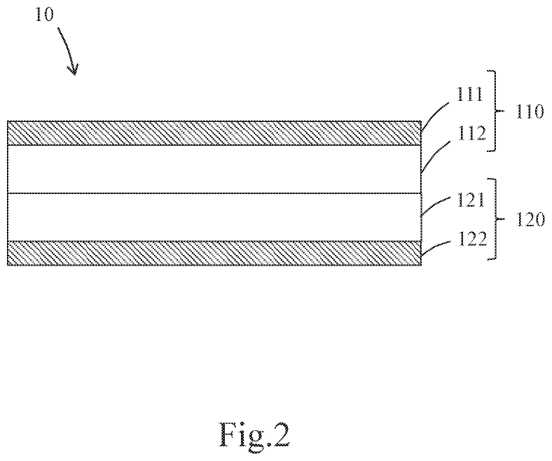

Refer to FIG. 1 and FIG. 2. FIG. 1 is a schematic diagram illustrating a recyclable composite zipper bag 1 according to an embodiment of the present invention. FIG. 2 is a cross-sectional view of a bag body 10 according to an embodiment of the present invention.

In the embodiment, the recyclable composite zipper bag 1 includes a bag body 10 and a zipper portion 20. The top of the bag body 10 has an opening 101. The zipper portion 20 is formed at the top of the bag body 10 close to the opening 101. The bag body 10 has three side edges 102 except top edge. At least two side edges 102 of two composite films 110 and 120 are bonded by heat seal to form the bag body 10. FIG. 2 schematically illustrates that three side edges 102 of the composite films 110 and 120 are bonded by heat seal. The composite film 110 includes an outer layer 111 and an inner layer 112. The outer layer 111 and the inner layer 112 are combined with each other. The composite film 120 includes an outer layer 121 and an inner layer 122. The outer layer 111 and the inner layer 112 are combined with each other. The outer layers 111 and 121 are biaxially oriented polyethylene (BOPE) films and the inner layers 112 and 122 are post-consumer recycled polyethylene (PCR PE) films. The BOPE is easy to print and used to increase impact and punch resistance. The inner layer 112 of the composite film 110 and the inner layer 122 of the composite film 120 are opposite to each other and superimposed.

Specifically, the composite film 110 has the outer layer 111 of 30-40 percentage weight (wt %) and the inner layer 112 of 70-60 wt %. The composite film 120 has the outer layer 121 of 30-40 percentage weight (wt %) and the inner layer 122 of 70-60 wt %. In other words, the weight ratio of the outer layer 111 or 121 to the inner layer 112 or 122 of the composite film 110 or 120 is 3/7-2/3. Specifically, the inner layer 112 or 122 of the composite film 110 or 120 has a thickness of 20-100 μm and the outer layer 111 or 121 of the composite film 110 or 120 has a thickness of 15-70 μm.

The PCR PE film of the present invention is made of recycled materials. The sources of the recycled materials are more complex. Thus, the recycled materials may include various types of polyethylene materials. The physical and chemical properties of the recycled polyethylene materials are more unstable than those of a single recycled polyethylene material. As a result, the recycled polyethylene materials are bonded by heat seal at a temperature of 120-130° C., lest the heat-seal edges of the composite films wrinkle. Specifically, the PCR PE film may include, but not limited to, at least one of high density polyethylene (HDPE), medium density polyethylene (MDPE), low density polyethylene (LDPE), ultra-low density polyethylene (ULDPE), and linear low density polyethylene (LLDPE). In the composite film of the present invention, the BOPE film of the outer layer and the PCR PE film of the inner layer belong to a polyethylene material. As a result, the composite film can be directly recycled and reused without separating the outer layer from the inner layer.

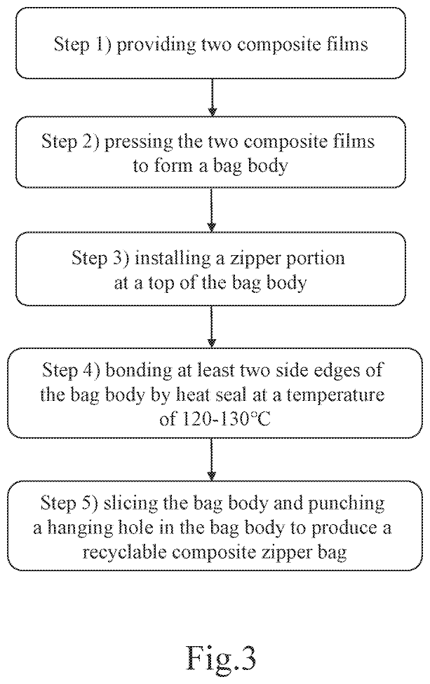

Refer to FIG. 3. FIG. 3 illustrates the steps of a method for producing a recyclable composite zipper bag 1 according to an embodiment of the present invention. The method includes:

Step 1): a BOPE film and a PCR PE film are respectively obtained, the inner side of the BOPE film is printed, the printed BOPE film and the PCR PE film are glued or heated (e.g., at 220° C. in the embodiment) to combine the printed BOPE film with the PCR PE film, thereby forming a composite film 110 or 120 in FIG. 2. Two composite films 110 and 120 are provided. Each composite film 110 or 120 includes an outer layer 111 or 121 and an inner layer 112 or 122. The outer layer 111 or 121 is a BOPE film. The inner layer 112 or 122 is a PCR PE film. In the embodiment, the composite film 110 includes the outer layer 111 of 38.46 wt % and the inner layer 112 of 61.54 wt %, and the composite film 120 includes the outer layer 121 of 38.46 wt % and the inner layer 122 of 61.54 wt %.

Step 2): the composite films 110 and 120 are sliced and pressed by a bag making machine to form a bag body 10 in FIG. 1.

Step 3): a zipper portion 20 is installed at the top of the bag body 10 close to the opening 101 and the zipper portion 20 is combined with the composite films 110 and 120 by an ultrasonic fusion bonding method.

Step 4) two side edges 102 of the bag body 10 are bonded by heat seal at a temperature of 120-130° C.

Step 5) the bag body 10 is sliced and a hanging hole is punched in the bag body 10 to produce a recyclable composite zipper bag 1. In the embodiment, the recyclable composite zipper bag 1 may have a length of 205 mm and a width of 260 mm.

In order to explain and verify the technical effect of the recyclable composite zipper bag of the present invention, the following experiments will be performed.

In the experiment of the present invention, it is determined whether the bag body wrinkles and the tear resistance of the seal edge of the bag body is measured when the composite films including the PCR PE films of different ratios are used. The results are shown in Table 1. It is observed that the recyclable composite zipper bag of the present invention indeed overcomes the problem that the side edge of the bag body easily wrinkles after bonding by heat seal and that the side edge of the bag body has high tear resistance.

TABLE 1

| Ratio of PCR | Tear resistance | Determining whether bag |
|---|---|---|
| PE (%) | of seal side edge | body wrinkles |
| 70% | >100N | No |
| 50% | >100N | No |
| 30% | >100N | No |
| 10% | >100N | No |

Then, the overprint error of zipper bags formed by different films is measured. The results are shown in Table 2. It is observed that the recyclable composite zipper bag of the present invention including a BOPE film and a PCR PE film has the minimum overprint error.

TABLE 2

| Composition of film | Overprint error |
|---|---|
| BOPE + PCR PE (present invention) | <2 mm |
| PE + PE | >5 mm |
| PE + PCR PE | >5 mm |

In addition, the present invention determines the puncture resistance of zipper bags formed by different films A needle is made of polypropylene (PP), wherein the needle has a diameter of 1 mm and the magnitude of a puncture force is 10 N. The results are shown in Table 3. It is observed that the recyclable composite zipper bag of the present invention including a BOPE film and a PCR PE film has the largest puncture resistance. The recyclable composite zipper bag is not easily pierced by sharp objects.

TABLE 3

| Composition of film | Puncture-resistant effect |
|---|---|
| BOPE + PCR PE (present invention) | Bag body is not pierced |
| PE + PE | Bag body is pierced |
| PE + PCR PE | Bag body is pierced |

In conclusion, the recyclable composite zipper bag and the method for producing the same of the present invention bond at least two side edges of two composite films by heat seal to form a bag body. The outer layer and the inner layer of each composite film are respectively a BOPE film and a PCR PE film. The composite film, having high impact and puncture resistance, is not easily pierced by sharp objects. The composite film is suitable for packaging some products, such as dental floss picks. The composite film belongs to polyethylene materials and includes the recycled material, which is helpful in recycling and reusing the composite film to achieve the ideal goal of plastic reduction and sustainable development. The method for producing a recyclable composite zipper bag has a simple production process and bonds the composite films by heat seal at 120-130° C. The method can effectively reach a melting point and avoid negative affection caused by too high temperature and wrinkling. The method does not cause inaccurate overprint but successfully produces a composite zipper bag that includes a BOPE film and a PCR PE film, thereby increasing the yield of products and greatly improving the competitiveness of industries.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A recyclable composite zipper bag comprising a bag body and a zipper portion formed at a top of the bag body, at least two side edges of two composite films are bonded by heat seal to form the bag body, characterized in that each of the two composite films comprises:
an outer layer being a biaxially oriented polyethylene (BOPE) film; and
an inner layer being a post-consumer recycled polyethylene (PCR PE) film, wherein the outer layer and the inner layer are combined with each other;
wherein the inner layers of the two composite films are opposite to each other.

2. The recyclable composite zipper bag according to claim 1, wherein the two composite films are bonded by heat seal at a temperature of 120-130° C.

3. The recyclable composite zipper bag according to claim 1, wherein the post-consumer recycled polyethylene film comprises at least one of high density polyethylene (HDPE), medium density polyethylene (MDPE), low density polyethylene (LDPE), ultra-low density polyethylene (ULDPE), and linear low density polyethylene (LLDPE).

4. The recyclable composite zipper bag according to claim 1, wherein a weight ratio of the outer layer to the inner layer of the composite film is 3/7-2/3.

5. The recyclable composite zipper bag according to claim 1, wherein the inner layer has a thickness of 20-100 μm and the outer layer has a thickness of 15-70 μm.

6. A method for producing a recyclable composite zipper bag comprising:
Step 1) providing two composite films, wherein each of the two composite films comprises:
an outer layer being a biaxially oriented polyethylene (BOPE) film; and
an inner layer being a post-consumer recycled polyethylene (PCR PE) film, wherein the outer layer and the inner layer are combined with each other;
Step 2) pressing the two composite films to form a bag body;
Step 3) installing a zipper portion at a top of the bag body; and
Step 4) bonding at least two side edges of the bag body by heat seal at a temperature of 120-130° C.

7. The method for producing a recyclable composite zipper bag according to claim 6, wherein Step 1) includes:
printing an inner side of the outer layer and gluing or heating the printed outer layer and the inner layer to combine the printed outer layer with the inner layer.

8. The method for producing a recyclable composite zipper bag according to claim 6, wherein the post-consumer recycled polyethylene film comprises at least one of high density polyethylene (HDPE), medium density polyethylene (MDPE), low density polyethylene (LDPE), ultra-low density polyethylene (ULDPE), and linear low density polyethylene (LLDPE).

9. The method for producing a recyclable composite zipper bag according to claim 6, wherein a weight ratio of the outer layer to the inner layer of the composite film is 3/7-2/3.

10. The method for producing a recyclable composite zipper bag according to claim 6, wherein the inner layer has a thickness of 20-100 μm and the outer layer has a thickness of 15-70 μm.
